(19) United States
(12) Patent Application Publication
(10) Pub. No.: US 2005/0017709 A1
(43) Pub. Date: Jan. 27, 2005

(54) Magnetoresistive turbocharger compressor wheel speed sensor

(75) Inventors: Joel D. Stolfus, Freeport, IL (US); Nicholas F. Busch, Freeport, IL (US)

Correspondence Address: HONEYWELL INTERNATIONAL INC., 101 COLUMBIA ROAD, P O BOX 2245, MORRISTOWN, NJ, 07962-2245, US

(73) Assignee: Honeywell International Inc.

(21) Appl. No.: 10/627,420

(22) Filed: Jul. 25, 2003

(51) Int. Cl. G01P 3/46

(52) U.S. Cl. 324/174

(57) ABSTRACT

A turbocharger includes a cylindrical wall and a non-ferromagnetic compressor wheel within the cylindrical wall. The non-ferromagnetic compressor wheel has fins. A magnetoresistive sensor housing is threaded through the cylindrical wall and houses a permanent magnet and at least one magnetoresistor. The permanent magnet is positioned so as to induce eddy currents on the fins. The permanent magnet magnetically biases the magnetoresistor, and the magnetoresistor senses rotation of the non-ferromagnetic compressor wheel.

### TECHNICAL FIELD OF THE INVENTION

The present invention relates to the use of a magnetoresistive sensor to sense the speed of a rotating non-ferromagnetic device such as the wheel of a turbocharger compressor.

### BACKGROUND OF THE INVENTION

Turbocharging is the force feeding of an engine with air under pressure in order to improve the fuel economy, emissions, and performance of the engine. In a typical turbocharger, an engine's exhaust is used to drive a turbine wheel which in turn drives a compressor wheel through a shaft that interconnects the turbine and compressor wheels. The compressor wheel of the turbocharger draws air into the turbocharger and moves the air by centrifugal force to the outlet of the turbocharger for supply to the engine.

Frequently, a turbocharger is controlled in an open loop manner, meaning that the speed of the compressor wheel is not used to provide feedback in order to control the speed of the compressor wheel. Therefore, in order to avoid an over speed condition that can damage or destroy the turbocharger, the turbocharger is run far below its maximum speed. However, running a turbocharger too far below its maximum speed results in less than optimal performance of the engine supplied by the open loop controlled turbocharger.

Therefore, it is desirable to sense the speed of a turbocharger's compressor wheel so that the turbocharger can be controlled nearer to its maximum speed. Sensing the speed of the compressor wheel of the turbocharger also has other advantages. For example, sensing the speed of the compressor wheel allows the turbocharger to be controlled so that it runs very near it's maximum speed limit, where its performance is best. Moreover, many turbocharger warranty claims are caused by over speed conditions, and many of these over speed warranty claims are due to the inability of current turbocharger control systems to accurately sense and control the speed of the turbocharger's compressor wheel.

Compressor wheels are typically made from aluminum, which is a non-ferromagnetic material. Therefore, it is problematic to sense the speed of such compressor wheels magnetically. For example, magnetoresistive sensors are currently used to sense ferrous metal targets but not non-ferrous metal targets.

Typically, a magnetoresistive sensor is biased by a stationary magnet. When the ferrous metal target being sensed by the magnetoresistive sensor has teeth and slots, the bias of the magnetoresistive sensor is influenced by the pole piece effect from the target teeth and slots as they pass in front of the magnetoresistive sensor and magnet. Such magnetoresistive sensors have not been used to sense the speed of non-ferromagnetic turbocharger compressor wheels.

The present invention is directed to a magnetoresistive sensor that is arranged to sense the speed of a non-ferromagnetic turbocharger compressor wheel.

### SUMMARY OF THE INVENTION

According to one aspect of the present invention, an apparatus comprises a non-ferromagnetic compressor wheel of a turbocharger, a permanent magnet, and at least one magnetoresistor. The non-ferromagnetic compressor wheel has fins. The permanent magnet is positioned so as to induce eddy currents on the fins. The magnetoresistor is positioned with respect to the non-ferromagnetic compressor wheel and the permanent magnet so as to be magnetically biased by the permanent magnet and so as to sense rotation of the non-ferromagnetic compressor wheel.

According to another aspect of the present invention, an apparatus comprises a non-ferromagnetic compressor wheel of a turbocharger, a magnetic field sensor housing, a permanent magnet, and an active magnetic field sensor. The non-ferromagnetic compressor wheel has fins. The magnetic field sensor housing is attached to a structure in proximity to the non-ferromagnetic compressor wheel. The permanent magnet is disposed within the magnetic field sensor housing and is positioned so as to induce eddy currents on the fins. The active magnetic field sensor is disposed within the magnetic field sensor housing and is positioned with respect to the non-ferromagnetic compressor wheel and the permanent magnet so as to be magnetically biased by the permanent magnet and so as to sense a magnetic field induced by the eddy currents to thereby detect rotation of the non-ferromagnetic compressor wheel.

According to still another aspect of the present invention, a method of sensing rotation of a non-ferromagnetic compressor wheel of a turbocharger comprises the following: inducing eddy currents in fins of the non-ferromagnetic compressor wheel; sensing a magnetic field induced by the eddy currents by use of an active magnetic field sensor so as to produce pulses having a pulse rate dependent upon a speed at which the non-ferromagnetic compressor wheel rotates; and, reducing the pulse rate.

### BRIEF DESCRIPTION OF THE DRAWINGS

These and other features and advantages of the present invention will become more apparent from a detailed consideration of the invention when taken in conjunction with the drawings in which:

FIG. 1 illustrates a compressor section of a turbocharger where the compressor section includes a compressor wheel and a magnetoresistive sensor for sensing the speed of the compressor wheel according to the present invention;

FIG. 2 illustrates the compressor wheel of FIG. 1 in additional detail;

FIG. 3 illustrates the relationship between the compressor wheel and the magnetoresistive sensor of FIG. 1;

FIGS. 4 and 5 are respective isometric and side views of the magnetoresistive sensor of FIG. 1;

FIG. 6 illustrates the magnetoresistive sensor of FIG. 1 in additional detail;

FIG. 7 illustrates the permanent magnet of the magnetoresistive sensor of FIG. 1;

FIG. 8 illustrates a magnetoresistive bridge of the magnetoresistive sensor of FIG. 1;

FIG. 9 illustrates a processing circuit that can be advantageously used with the magnetoresistive sensor of FIG. 1; and,

FIG. 10 shows an alternate mounting arrangement for the magnetoresistive sensor.

### DETAILED DESCRIPTION

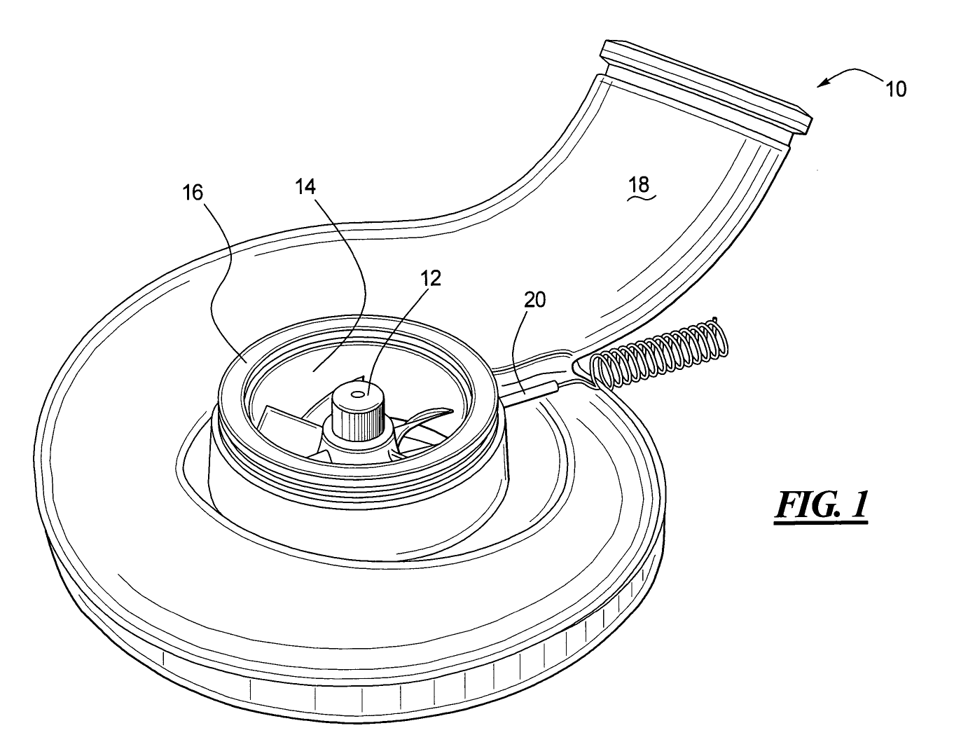

A compressor section 10 of a turbocharger is shown in FIG. 1 and includes a turbocharger compressor wheel 12 that rotates within a cylindrical chamber 14 formed by a cylindrical wall 16. The turbocharger compressor wheel 12 is typically rotated by a turbine wheel (not shown) and the turbine wheel may be suitably controlled to rotate the turbocharger compressor wheel 12 at a desired speed. Accordingly, the turbocharger compressor wheel 12 draws air into the cylindrical chamber 14 (from above as shown in FIG. 1) and supplies the air under pressure through an outlet 18 to an engine such as a diesel or gasoline engine.

A magnetoresistive sensor 20 is received in an aperture of the cylindrical wall 16 in order to sense the speed at which the turbocharger compressor wheel 12 rotates within the cylindrical chamber 14.

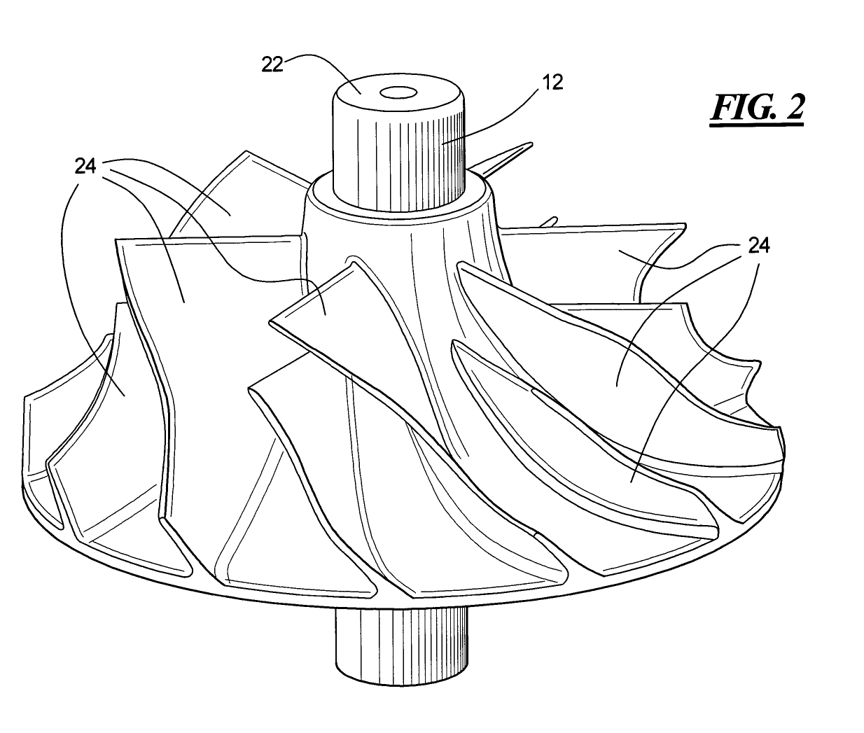

As shown in FIG. 2, the turbocharger compressor wheel 12 has a shaft 22 and a plurality of fins 24 radiating out from the shaft 22. The turbocharger compressor wheel 12 is driven by the turbine wheel that is suitably coupled to the shaft 22. The fins 24 are optimally shaped to compress air and to impel the compressed air through the outlet 18 as the shaft 22 rotates the fins 24. FIG. 3 shows an exemplary geometric relationship between the fins 24 of the turbocharger compressor wheel 12 and the magnetoresistive sensor 20.

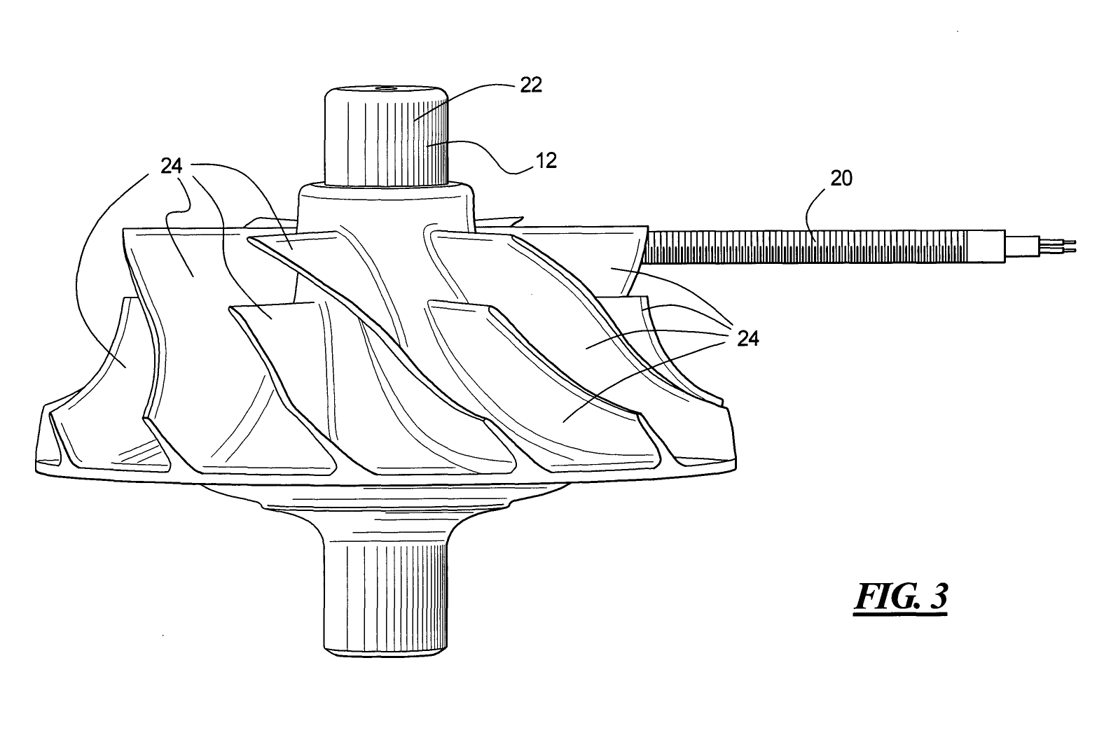

As shown in FIGS. 4 and 5, the magnetoresistive sensor 20 includes a housing 26. The housing 26 has a first portion 28 that is externally threaded so that the magnetoresistive sensor 20 can be threaded through the cylindrical wall 16 and into position where it can sense the rotation of the turbocharger compressor wheel 12. The housing 26 has a second portion 30 that is faceted to receive a wrench or other tool to facilitate the turning of the magnetoresistive sensor 20 in order to thread the magnetoresistive sensor 20 through the cylindrical wall 16 of the compressor section 10. The magnetoresistive sensor has a third portion 32 through which electrical leads 34 may be run in order to couple the magnetoresistive sensing elements located within the housing 26 to a controller or other apparatus that is located externally of the housing 26. The housing 26, for example, my be a stainless steel housing made from 300 series stainless steel.

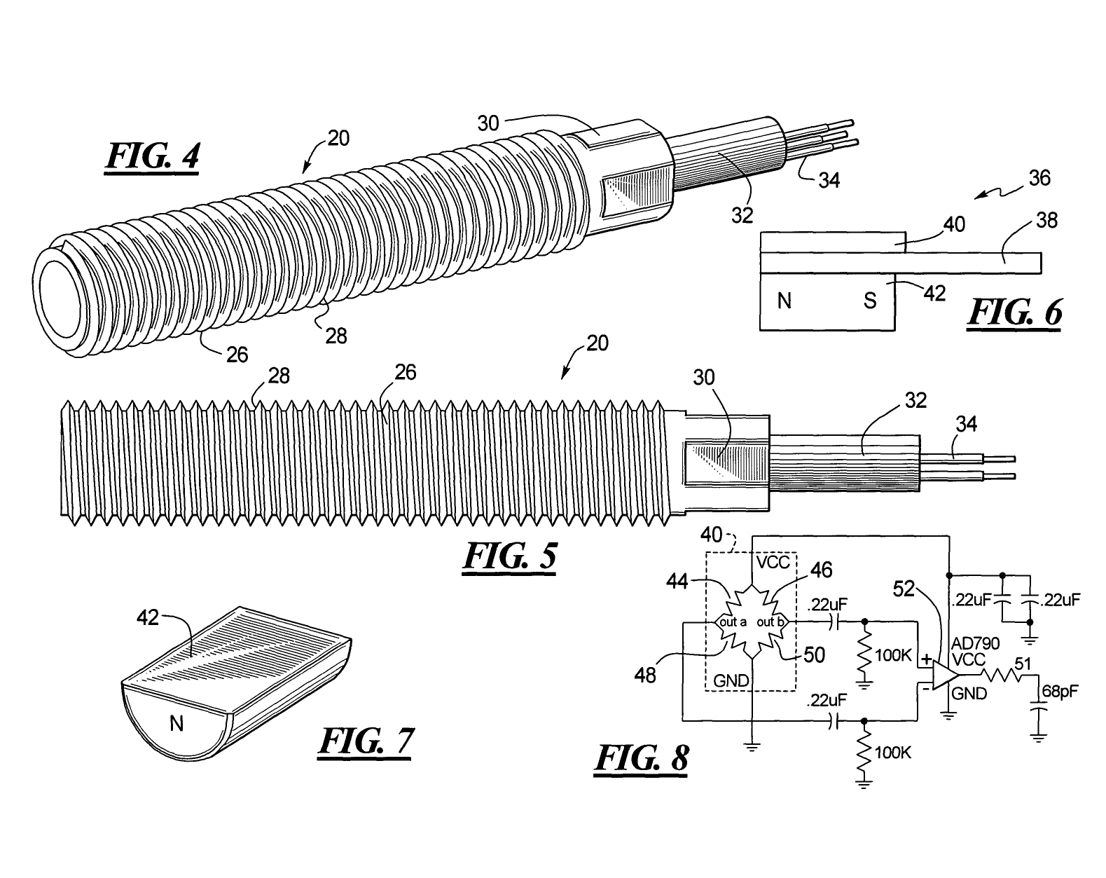

FIG. 6 shows a magnetoresistive subassembly 36 that is housing within the housing 26 of the magnetoresistive sensor 20. The magnetoresistive subassembly 36 includes a chip carrier 38, a magnetoresistive chip 40 supported by the chip carrier 38 on one side thereof, and a permanent magnet 42 supported by the chip carrier 38 on another side thereof. Accordingly, the chip carrier 38 is sandwiched between the magnetoresistive chip 40 and the permanent magnet 42. Alternatively, the permanent magnet 42 may be supported by the magnetoresistive chip 40. In this case, the magnetoresistive chip 40 is supported on the chip carrier 38, and the permanent magnet 42 is supported on the magnetoresistive chip 40. Other orientations of the chip carrier 38, the magnetoresistive chip 40, and the permanent magnet 42 relative to one another are also possible. The permanent magnet 42 is shown in FIG. 7 and includes a flat surface that abuts the magnetoresistive chip 40 as shown in FIG. 6.

A North-South axis of the permanent magnet 42 extends between the North and South poles of the permanent magnet 42. This North-South axis is parallel to the longitudinal axis of the magnetoresistive sensor 20. For example, the magnetoresistive sensor 20 may be positioned with respect to the turbocharger compressor wheel 12 so that the North-South axis of the permanent magnet 42 intersects the shaft 22 of the turbocharger compressor wheel 12. The permanent magnet 42 magnetically biases the magnetoresistors of the magnetoresistive sensor 20.

As shown in FIG. 8, the magnetoresistive chip 40 comprises four magnetoresistors 44, 46, 48, and 50 formed in a semiconductor substrate as a Wheatstone bridge. The junction of the magnetoresistors 44 and 46 is coupled to a source that is shared with a comparator 52 which may be an operational amplifier. The junction of the magnetoresistors 48 and 50 is coupled to a reference potential such as ground. The junction of the magnetoresistors 46 and 50 is coupled to the positive input of the comparator 52, and the junction of the magnetoresistors 44 and 48 is coupled to the negative input of the comparator 52. An amplifier may be placed upstream of the comparator 52 as necessary.

Alternatively, instead of integrating the magnetoresistors 44, 46, 48, and 50 on a semiconductive substrate to form a chip, the magnetoresistors 44, 46, 48, and 50 may be formed as discrete elements mounted, for example, on a printed circuit board. Also, in the case where the magnetoresistors 44, 46, 48, and 50 are integrated on a semiconductive substrate, the comparator 52 may be likewise integrated on the same substrate, in which case the output of the comparator 52 is brought out of the magnetoresistive sensor 20 by way of the leads 34. Alternatively, the comparator 52 may be external of the housing 26 in which case the leads 34 are used to couple the output of the magnetoresistors 44, 46, 48, and 50 to the comparator 52. As a still further alternative, fewer or more than four magnetoresistors may be used in the magnetoresistive sensor 20.

With the arrangement as described above, eddy currents are induced in the fins 24 of the turbocharger compressor wheel as the fins 24 are rotated by the permanent magnet 42. These eddy currents flowing in the aluminum fins 24 of the turbocharger compressor wheel 12 at high RPM cause a magnetic field that opposes the magnetic field created by the permanent magnet 42. The magnetoresistors 44, 46, 48, and 50 of the magnetoresistive sensor 20 detect this magnetic field created by these eddy currents. The magnetoresistive sensor 20 is placed in a region to detect the magnetic field induced by the eddy currents in order to produce a signal that can be used to measure the travel of each of the fins 24 past the magnetoresistive sensor 20. The measurement of the number of the fins 24 per given duration of time can be used to determine the speed of the turbocharger compressor wheel 12.

The sensed speed of the turbocharger compressor wheel 12 can be used for a variety of purposes. For example, the sensed speed can simply be recorded. During warranty negotiations, this record provides evidence of whether or not the speed specification of the turbocharger had been exceeded by the customer. Instead of recoding all speed readings for this purpose, only the maximum compressor speed need be stored. Accordingly, as each new compressor speed reading is made, it is compared to the stored maximum compressor speed reading and, if the new compressor speed reading is greater than the stored maximum compressor speed reading, the new compressor speed reading becomes the stored maximum compressor speed reading. The stored maximum compressor speed reading can be used for a variety of purposes. For example, if the stored maximum speed of the compressor exceeds design specifications, warranty claims can be refuted. Additionally or alternatively, the sensed speed can be used by a controller to eliminate most or all over speed conditions altogether.

Moreover, it may be necessary to divide down the number of pulses per revolution produced by the magnetoresistive sensor 20 in response to rotation of the turbocharger compressor wheel 12 due to limitations of control processors that keep track of the sensor output at high RPM. Compressor wheels also have different numbers of fins from one turbocharger to another.

Accordingly, a circuit 60 as a shown in FIG. 9 may be used to regulate the number of output pulses per revolution of the turbocharger compressor wheel 12. The output of the magnetoresistive sensor 20 is coupled to a counter 62 whose outputs are selectively coupled as inputs to a NAND gate 64. The outputs of the counter 62 that are coupled to the NAND gate 64 may be selected to produce a desired divide-by number N. Thus, the counter 62 and the NAND gate 64 together divide the pulse rate at which the magnetoresistive sensor 20 emits pulses by N. A J-K flip-flop 66 further reduces this pulse rate by two. The output of the J-K flip-flop 66 is coupled to the base of an NPN transistor 68 whose output forms the output of the circuit 60. In this manner, the circuit 60 can be used to divide down the number of pulses per revolution produced by the magnetoresistive sensor 20 in response to rotation of the turbocharger compressor wheel 12 so as to meet limitations of the control processors that keep track of the sensor output. The circuit 60 can also be used to regulate the number of pulses per revolution produced by the magnetoresistive sensor 20 in response to rotation of the turbocharger compressor wheel 12 to a consistent number regardless of the number of fins of a compressor wheel. The duty cycle of the pulses at the output of the NPN transistor 68 is 50%.

As in the case of the arrangement shown in FIG. 8, the circuit 60 may be integrated on the same substrate as the magnetoresistors of the magnetoresistive sensor 20, in which case the output of the circuit 60 is brought out of the magnetoresistive sensor 20 by way of the leads 34. Alternatively, the circuit 60 may be external of the housing 26 in which case the leads 34 are used to coupled the output of the magnetoresistors 44, 46, 48, and 50 to the circuit 60.

Certain modifications of the present invention have been discussed above. Other modifications will occur to those practicing in the art of the present invention. For example, magnetoresistive elements as disclosed above are active magnetic field sensors (requiring a voltage stimulus) that are used to sense the magnetic fields induced by the eddy currents flowing on the surfaces of the fins of the compressor wheel. These magnetoresistive elements can be magnetoresistors, giant magnetoresistors (GMR), anisotropic magnetoresistors (AMR), etc. Alternatively, other active magnetic field sensors such as Hall effect sensors can be used to sense the magnetic fields induced by the eddy currents flowing on the surfaces of the fins of the compressor wheel.

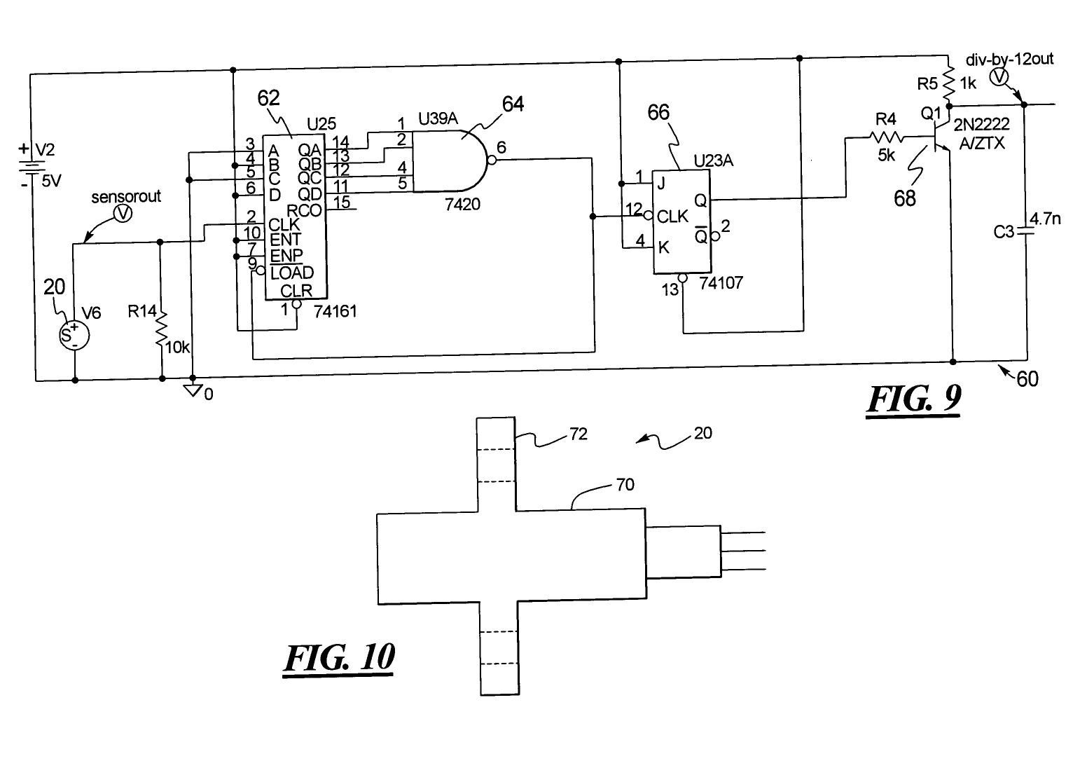

Also, the first portion 28 of the housing 26 is described above as being externally threaded so that the magnetoresistive sensor 20 can be threaded through the cylindrical wall 16. Instead, the housing 26 may be unthreaded and instead may have a flange for screw mounting to the cylindrical wall. Such a mounting arrangement is shown in FIG. 10 where the magnetoresistive sensor 20 has a housing 70 with a flange 72 that is arranged to receive one or more screws for fastening the magnetoresistive sensor 20 to the cylindrical wall 16.

Moreover, the magnetoresistive sensor 20 is described above as being mounted into the cylindrical wall 16 in order to sense the speed at which the turbocharger compressor wheel 12 rotates within the cylindrical chamber 14. Alternatively, the magnetoresistive sensor 20 could instead sense the compressor wheel through the turbo housing. Instead of boring a hole all the way through the housing, a blind hole that has a thin face could receive magnetoresistive sensor 20 with the magnetoresistive sensor 20 detect rotation through the thin face.

Accordingly, the description of the present invention is to be construed as illustrative only and is for the purpose of teaching those skilled in the art the best mode of carrying out the invention. The details may be varied substantially without departing from the spirit of the invention, and the exclusive use of all modifications which are within the scope of the appended claims is reserved.

1. An apparatus comprising:
a non-ferromagnetic compressor wheel of a turbocharger, the non-ferromagnetic compressor wheel having fins;
a permanent magnet positioned so as to induce eddy currents on the fins; and,
at least one magnetoresistor positioned with respect to the non-ferromagnetic compressor wheel and the permanent magnet so as to be magnetically biased by the permanent magnet and so as to sense rotation of the non-ferromagnetic compressor wheel.

2. The apparatus of claim 1 wherein the permanent magnet has a North-South axis, and wherein the North-South axis is pointed at the non-ferromagnetic compressor wheel.

3. The apparatus of claim 1 wherein the permanent magnet and the magnetoresistor are housed with a housing having external threads, and wherein the housing is threaded into a wall near the non-ferromagnetic compressor wheel.

4. The apparatus of claim 3 wherein the housing has a faceted portion arranged to receive a tool for turning the housing into the wall.

5. The apparatus of claim 1 wherein the permanent magnet and the magnetoresistor are housed with a housing having a screw receiving flange for fastening to a wall near the non-ferromagnetic compressor wheel.

6. The apparatus of claim 1 wherein the permanent magnet abuts the magnetoresistor.

7. The apparatus of claim 1 wherein the magnetoresistor is coupled to a comparator.

8. The apparatus of claim 1 wherein the magnetoresistor produces pulses as the fins travel past the magnetoresistor, wherein the magnetoresistor is coupled to a pulse divider, and wherein the pulse divider divides the pulses produced by the magnetoresistor.

9. The apparatus of claim 8 wherein the permanent magnet has a North-South axis, and wherein the North-South axis is pointed at the non-ferromagnetic compressor wheel.

10. The apparatus of claim 8 wherein the permanent magnet and the magnetoresistor are housed with a housing having external threads, and wherein the housing is threaded into a wall near the non-ferromagnetic compressor wheel.

11. The apparatus of claim 10 wherein the housing has a faceted portion arranged to receive a tool for turning the housing into the wall.

12. The apparatus of claim 8 wherein the permanent magnet and the magnetoresistor are housed with a housing having a screw receiving flange for fastening to a wall near the non-ferromagnetic compressor wheel.

13. The apparatus of claim 8 wherein the permanent magnet abuts the magnetoresistor.

14. An apparatus comprising:
a non-ferromagnetic compressor wheel of a turbocharger, the non-ferromagnetic compressor wheel having fins;
a magnetic field sensor housing attached to a structure in proximity to the non-ferromagnetic compressor wheel;
a permanent magnet disposed within the magnetic field sensor housing and positioned so as to induce eddy currents on the fins; and,
an active magnetic field sensor disposed within the magnetic field sensor housing and positioned with respect to the non-ferromagnetic compressor wheel and the permanent magnet so as to be magnetically biased by the permanent magnet and so as to sense a magnetic field induced by the eddy currents to thereby detect rotation of the non-ferromagnetic compressor wheel.

15. The apparatus of claim 14 wherein the permanent magnet has a North-South axis, and wherein the North-South axis is pointed at the non-ferromagnetic compressor wheel.

16. The apparatus of claim 14 wherein the permanent magnet abuts the active magnetic field sensor.

17. The apparatus of claim 16 wherein the permanent magnet has a North-South axis, and wherein the North-South axis is pointed at the non-ferromagnetic compressor wheel.

18. The apparatus of claim 14 wherein the active magnetic field sensor is coupled to a comparator.

19. The apparatus of claim 14 wherein the active magnetic field sensor produces pulses as the fins travel past the active magnetic field sensor, wherein the active magnetic field sensor is coupled to a pulse divider, and wherein the pulse divider divides the pulses by at least two.

20. The apparatus of claim 19 wherein the permanent magnet has a North-South axis, and wherein the North-South axis is pointed at the non-ferromagnetic compressor wheel.

21. The apparatus of claim 19 wherein the permanent magnet abuts the active magnetic field sensor.

22. The apparatus of claim 21 wherein the permanent magnet has a North-South axis, and wherein the North-South axis is pointed at the non-ferromagnetic compressor wheel.

23. The apparatus of claim 14 wherein the active magnetic field sensor comprises at least one giant magnetoresistive element.

24. The apparatus of claim 14 wherein the active magnetic field sensor comprises at least one anisotropic magnetoresistive element.

25. The apparatus of claim 14 wherein the active magnetic field sensor comprises at least one Hall effect sensing element.

26. A method of sensing rotation of a non-ferromagnetic compressor wheel of a turbocharger comprising:
inducing eddy currents in fins of the non-ferromagnetic compressor wheel;
sensing a magnetic field induced by the eddy currents by use of an active magnetic field sensor so as to produce pulses having a pulse rate dependent upon a speed at which the non-ferromagnetic compressor wheel rotates; and,
reducing the pulse rate.

27. The method of claim 26 wherein the reducing of the pulse rate comprises reducing the pulse rate by use of a divider.

28. The method of claim 26 wherein the permanent magnet has a North-South axis, and wherein the North-South axis is pointed at the non-ferromagnetic compressor wheel.

29. The method of claim 26 wherein the permanent magnet abuts the active magnetic field sensor.

30. The method of claim 29 wherein the permanent magnet has a North-South axis, and wherein the North-South axis is pointed at the non-ferromagnetic compressor wheel.

31. The method of claim 26 further comprising magnetically biasing the active magnetic field sensor.

32. The method of claim 31 wherein the active magnetic field sensor is biased and the eddy currents are induced by the same permanent magnet.

33. The method of claim 26 wherein the active magnetic field sensor comprises at least one giant magnetoresistive element.

34. The method of claim 26 wherein the active magnetic field sensor comprises at least one anisotropic magnetoresistive element.

35. The method of claim 26 wherein the active magnetic field sensor comprises at least one Hall effect sensing element.

36. The method of claim 26 further comprising storing a maximum compressor speed reading from the active magnetic field sensor.
